(19) United States
(12) Patent Application Publication
(10) Pub. No.: US 2020/0329635 A1
(43) Pub. Date: Oct. 22, 2020

(54) APPARATUS FOR CUTTING AGRICULTURAL PRODUCT

(71) Applicant: CRARY INDUSTRIES, INC., West Fargo, ND (US)

(72) Inventors: Robert D. Smith, Moorhead, MN (US); Ben Richard, Fargo, ND (US)

(21) Appl. No.: 16/812,571

(22) Filed: Mar. 9, 2020

Related U.S. Application Data
(60) Provisional application No. 62/835,829, filed on Apr. 18, 2019.

(51) Int. Cl. A01D 34/14; A01D 34/03

(52) U.S. Cl. CPC A01D 34/14; A01D 34/03

(57) ABSTRACT

An apparatus for cutting agricultural product having: a frame; a first cutting component; and a support for the first cutting component on the frame that is driven to cause the first cutting component to be moved in a cutting path. The first cutting component has a body with a first serrated cutting edge to sever agricultural product engaged thereagainst. The first cutting edge has a length and a plurality of teeth spaced from each other in a lengthwise direction. Each tooth has a tip, Spacing between the tooth tips is non-uniform over a majority of the length of the first cutting edge.

### BACKGROUND OF THE INVENTION

### Field of the Invention

This invention relates to apparatus for cutting agricultural product and, more particularly, to an apparatus having at least one cutting component with a serrated cutting edge.

### Background Art

Many different types of equipment have been designed to effect high volume cutting of agricultural product utilizing cutting components with serrated edges. A reciprocating cutter bar design has been used for decades to cut crops such as wheat, oats, rye, barley, soybeans, etc. An elongate bar/support carries a plurality of cutting components. The bar/support is reciprocated in typically a linear path to cause serrated cutting edges on the cutting components to cooperate with stationary components, such as fingers, to produce a scissors action that causes severance of the agricultural product.

Heretofore, the serrated cutting edges on these cutting components have been made up of teeth with tips spaced uniformly along the length of the cutting edges. The cutting components are designed to be readily assembled and disassembled, whereby cutting components of different configuration can be interchanged. Crop type and anticipated field conditions dictate the most effective and efficient tooth pitch (teeth per inch). Equipment manufacturers have routinely made available cutting components with different tooth pitch—from fine to extra-coarse—to allow users to select the cutting components with the optimal design for a particular operation.

For example, crops with a heavy stalk may require a coarse pitch due to the fact that this tooth arrangement is capable of producing a more direct piercing force to penetrate stalks during the cutting action.

On the other hand, crops with less rigid and softer cutting regions, such as grasses, are more efficiently severed with a finer pitch serrated edge which is not required to produce the aforementioned piercing action. The coarser serrated cutting edges do not effectively smoothly sever these less durable crops.

With this in mind, the industry has offered interchangeable cutting components with dedicated capabilities typically optimal for a certain type of crop and for certain field conditions. Thus, effectively severing crop with the least amount of force is achieved by a proper selection of the cutting components. While the cutting components are not particularly difficult to interchange, the process is nonetheless an inconvenience and time-consuming, which detracts from usable harvesting time.

Heretofore, in the interest of most effectively and efficiently operating a piece of harvesting equipment, harvesting equipment has been routinely customized throughout the harvesting season through the use of strategically selected cutting components to effect clean crop severance with minimal force application on the crop through the operative cutting components. Aside from contributing to more effective crop severance, the minimization of cutting force application through the cutting components ultimately controls wear on equipment and thus may account for an extended life thereof.

### SUMMARY OF THE INVENTION

In one form, the invention is directed to an apparatus for cutting agricultural product having: a frame; a first cutting component; and a support for the first cutting component on the frame that is driven to cause the first cutting component to be moved in a cutting path. The first cutting component has a body with a first serrated cutting edge to sever agricultural product engaged thereagainst. The first cutting edge has a length and a plurality of teeth spaced from each other in a lengthwise direction. Each tooth has a tip. A spacing between the tooth tips is non-uniform over a majority of the length of the first cutting edge.

In one form, the cutting path is a reciprocating cutting path.

In one form, the spacing between adjacent tooth tips includes at least two different spacings over a majority of the length of the first cutting edge.

In one form, first and second of the spacings alternate over a majority of the length of the first cutting edge.

In one form, the first and second spacings alternate directly, one after the other, over a majority of the length of the first cutting edge.

In one form, there are U-shaped valleys between adjacent of the tips on the first cutting edge.

In one form, there are valleys between adjacent of the tips on the first cutting edge defined by angled flat surfaces.

In one form, the first cutting edge moves in a substantially straight first line in the reciprocating cutting path. The first cutting edge is at a first angle to the first line.

In one form, the first angle is in the range of 50°-70° and more preferably on the order of 60°.

In one form, there are first and second different spacings between adjacent tips on the first cutting edge. The U-shaped valleys are located between adjacent of the tips with the greater of the first and second different spacings.

In one form, there are first and second different spacings between adjacent of the tips on the first cutting edge. The greater of the first and second different spacings corresponds to a pitch on the order of 0.258.

In one form, the lesser of the first and second different spacings corresponds to a pitch on the order of 0.109.

In one form, the first cutting component has a body with first and second oppositely facing surfaces. The cutting teeth are formed on a beveled surface extending between the oppositely facing surfaces.

In one form, the beveled surface is at an angle of 22°-25° with respect to one of the oppositely facing surfaces.

In one form, the first cutting component body has a second serrated cutting edge. The first and second cutting edges cooperatively define a “V” shape.

In one form, the second cutting edge has substantially the same configuration as the first cutting edge.

In one form, a plurality of cutting components the same as the first cutting component are provided on the support. The cutting components move as one piece with the support.

In one form, the first serrated cutting edge is substantially straight.

In one form, the apparatus for cutting agricultural product is provided in combination with a wheeled vehicle that supports the frame. The wheeled vehicle is operable to advance the apparatus in an operating direction that is at an angle to the reciprocating cutting path.

### BRIEF DESCRIPTION OF THE DRAWINGS

FIG. 1 is a schematic representation of a system for cutting agricultural product, including an apparatus for cutting agricultural product according to the present invention, that is advanced by a wheeled vehicle/combine;

FIG. 2 is a schematic representation of a cutting component on the inventive apparatus shown in FIG. 1;

FIG. 3 is a plan view of a prior art cutting component corresponding to that shown in FIG. 2;

FIG. 4 is a view of the cutting component in FIG. 3 from a different perspective;

FIG. 5 is a view as in FIG. 3 of another prior art cutting component;

FIG. 6 is a view of the cutting component in FIG. 5 from a different perspective;

FIG. 7 is a plan view of one preferred form of cutting component as shown schematically in FIGS. 1 and 2;

FIG. 8 is a view of the cutting component in FIG. 7 from a different perspective; and

FIG. 9 is a schematic representation of a generic form of cutting edge on a cutting component as shown in FIGS. 7 and 8, according to the invention.

### DETAILED DESCRIPTION OF THE PREFERRED EMBODIMENT

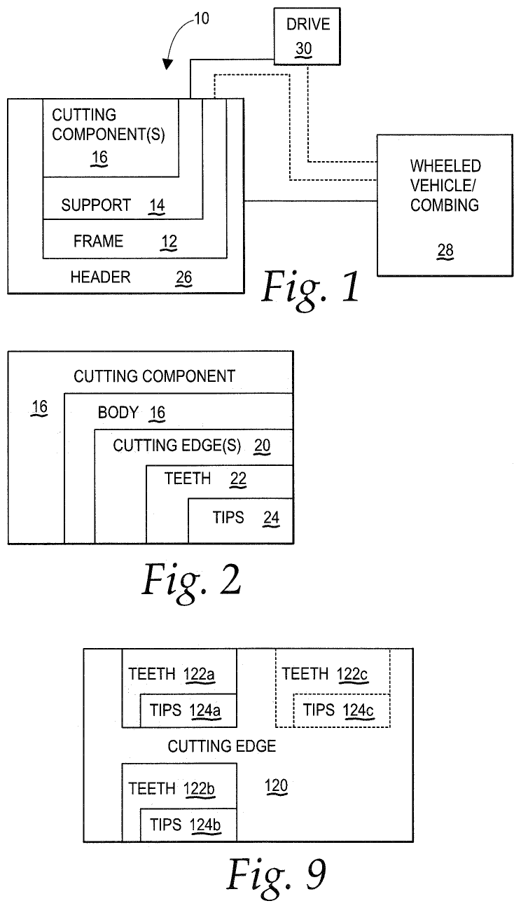

As shown schematically in FIG. 1, the invention is directed to an apparatus 10 for cutting agricultural product and consisting of a frame 12 and a support 14 on the frame 12 for at least one cutting component 16. As shown also in FIG. 2, each cutting component 16 has a body 18 with at least one serrated cutting edge 20 having a length and a plurality of teeth 22, with the teeth having tips 24 in spaced relationship along the length of each cutting edge 20. The serrated cutting edge 20 is configured to sever agricultural product engaged thereagainst.

In one exemplary form, the frame 12 is part of a header 26 attached to a wheeled vehicle, typically in the form of a combine 28, that is operable to advance the apparatus 10 in an operating direction. As shown in dotted lines, the frame 12 may be maintained directly upon the wheeled vehicle/combine 28 without requiring a typical header configuration.

The schematic showing of the components in FIGS. 1 and 2 is intended to encompass a wide range of forms for such components and their interaction, with exemplary components described in detail hereinbelow being exemplary in nature only. As just one example, the cutting edges 20 may be advanced against crop in many different manners, potentially through a manual input to effect severance of part of an agricultural product.

In a typical, but not required, known design, the support 14 is in the form of an elongate cutter bar to which the individual cutting components 16 are mounted to follow reciprocating movement thereof. Exemplary structures are shown in U.S. Pat. No. 7,503,162, to Herlyn et al. (Herlyn), and U.S. Pat. No. 7,658,059 (Majkrzak), the disclosures of which are incorporated herein by reference.

A basic cutting element component is depicted in the above prior art and is also currently commercially offered by the Applicant herein as its Crary Gold'N Cut™ product line as described at http://www.crary.com/Products/Cutting Systems. The Crary commercial product, which is used as an exemplary form of the cutting component to describe the inventive concept hereinbelow is, as noted above, but one potential configuration for the cutting components 16. Cutting components with different shapes, with single or multiple serrated cutting edges, cutting edges with straight or non-straight lengths, etc. are contemplated, as is a design that does not require a reciprocation of the cutting elements to effect product severance.

As shown in FIG. 1, the support 14 may be driven, in whatever particular path, whether reciprocating or not, through an appropriate drive 30, that could be independent of, or actuated by, the wheeled vehicle/combine 28.

In FIGS. 3 and 4, one exemplary prior art cutting component currently offered by the Applicant is shown at 16′ and consists of a body 18′, generally in the form of a flat plate. The body 18′ has separate, serrated, cutting edges 20a′, 20b′ each of which is straight, with the two cutting edges 20a′, 20b′ arranged to cooperatively define a “V” shape. The serrated cutting edges 20a′, 20b′ are formed in a beveled edge portion that is at an angle θ′ to the plane of the body 18′. The angle θ′ depicted is in the range of 22°-25°.

The cutting edges 20a′, 20b′ have the same configuration with cutting teeth 22′ spaced uniformly along the length L′ thereof. Each of the teeth 22′ has a tip 24′, with the tips 24′ likewise uniformly spaced along the length L′ of each of the cutting edges 20a′, 20b′.

In the depicted construction, there are nineteen teeth 22′ on each cutting edge 20a′, 20b′, with ten teeth per inch, as a result of which the pitch, or vertical spacing between adjacent tooth tips 24′ depicted as S′ in the FIG. 3 orientation, is 0.1 (0.01 inch). This vertical dimension is measured orthogonally to the tooth lengths and a substantially parallel reciprocating cutting path RP′ for the cutting component 16′.

Between adjacent tooth tips 24′ is a valley V′ defined by angled flat surfaces S1′, S2′.

FIGS. 5 and 6 show another prior art cutting component 16″ currently offered by the Applicant with a coarser pitch than that of the cutting component 16′. The cutting component 16″ has a body 18″ with separate straight cutting edges 20a″, 20b″. A similar bevel angle θ″ (22°-25° is formed on the body 18″ at the cutting edges 20a″, 20b″.

As depicted, the teeth 22″ have tips 28″, with a valley V″ with a U-shaped/scalloped configuration between adjacent tips 28″.

With the cutting edges 20a″, 20b″ each having the same length L″, there are 3-4 teeth 22″ per inch, with a preferred tooth pitch of approximately 0.3. As depicted, there are eight teeth 22″ on each cutting edge 20a″, 20b″. The relevant vertical dimensions for the teeth 22″, as depicted in the FIG. 5 orientation, are identified as S1″ (0.261 inch) and S2″ (0.305 inch). The vertical dimensions are taken orthogonally to the tooth lengths and the substantially parallel reciprocating cutting path RP″ for the cutting component 16″.

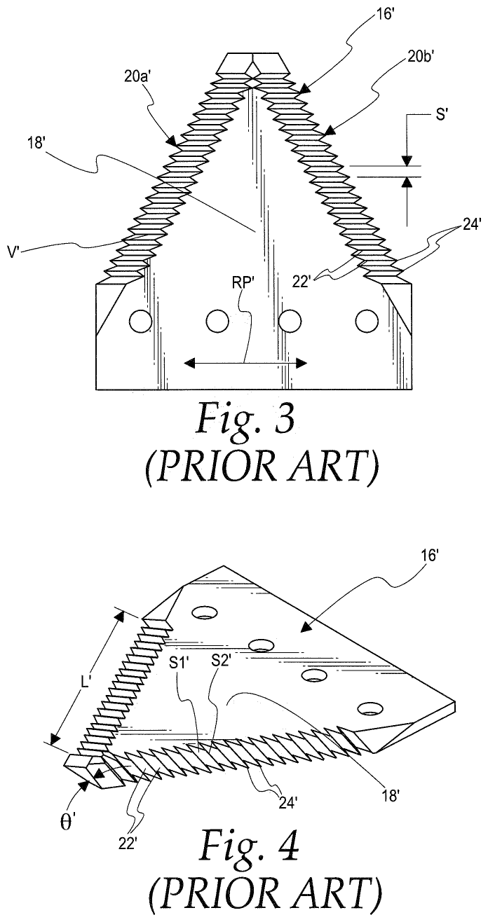

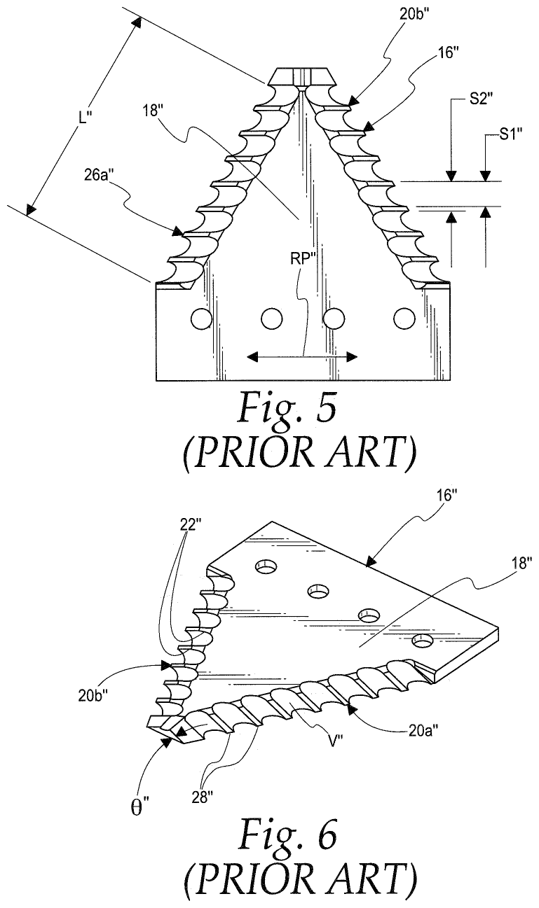

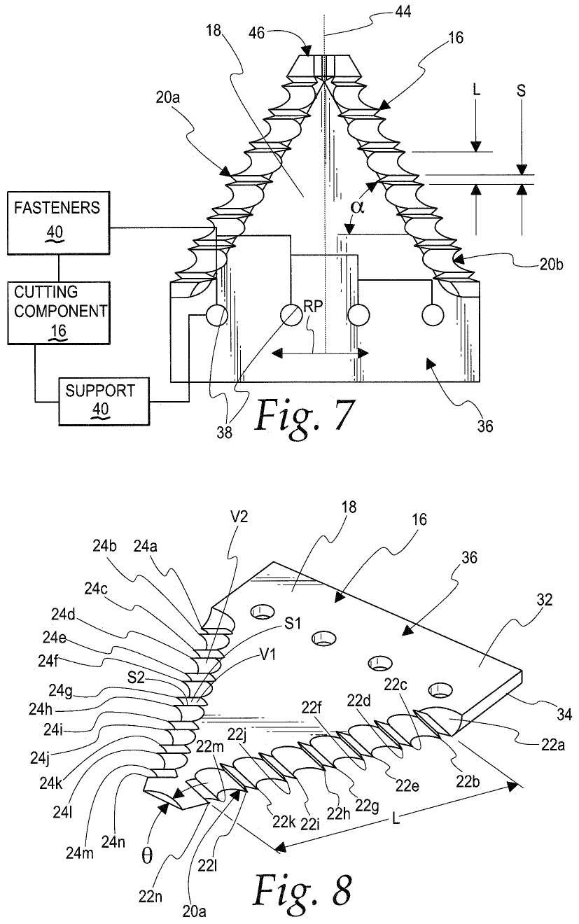

An exemplary cutting component, according to the present invention, and as depicted schematically in FIGS. 1 and 2, is shown at 16 in FIGS. 7 and 8. The cutting component 16 has a flat body 18 bounded by oppositely facing, substantially parallel, flat surfaces 32, 34.

The body 18 has the same general overall shape as the bodies 18′, 18″ in the prior art cutting components described hereinabove. The cutting edges 20a, 20b are straight, which is not a requirement, and together form a “V” shape as in the prior art components 16′, 16″. The cutting edges 20a, 20b are provided on beveled regions making an angle θ with the plane of the body 18, and each of its substantially parallel surfaces 32, 34. The angle θ is preferably in the range of 22°-25°.

The body 18 has a substantially rectangular mounting region at 36 with openings 38 therethrough to accommodate fasteners 40 that are used to removably secure the cutting components 16 to the support 14.

While not required, the support 14 will typically advance each attached cutting component 16 in a reciprocating cutting path. While again not so limited, the cutting path is commonly a straight line path as indicated by the double-headed arrow RP. This line of the cutting path is orthogonal to a line 44 that bisects the “V” defined cooperatively by the cutting edges 20a, 20b.

Before describing the details of the cutting edges 20a, 20b, it should be understood that at each end thereof, there is a transition region whereat the tooth configurations are somewhat varied. Accordingly, the description of the construction of the cutting edges 20a, 20b is concerned primarily with the configuration over a majority of the lengths L thereof, with it being understood that a tooth and valley arrangement, as depicted and described hereinbelow, varies somewhat: a) where the cutting edges 20a, 20b meet the mounting region 36 at one end; and b) at a tip configuration at 46 where the other ends of the cutting edges 20a, 20b converge. Thus, when referring to configuration over the lengths of the cutting edges 20a, 20b, it should be understood that this is a description applicable to a majority of the lengths thereof.

The depicted configuration for the cutting component 16 has cutting edges 20a, 20b with substantially the same configuration. Exemplary cutting edge 20b has fourteen tooth tips 24a-24n. As depicted, adjacent tooth tips 24 have different lengthwise spacing. In this exemplary form, there are two different spacings between adjacent teeth over a majority of the length of the cutting edge 20b. As depicted, the two tooth spacings directly alternate over the length of the cutting edge 20b between: a) a first spacing as shown between the tips 24a, 24b; 24c, 24d, etc.; and b) a second larger spacing between the tips 24b, 24c; 24d, 24e, etc.

In an exemplary form, the smaller tooth spacing results in a tooth pitch of approximately 0.109 with the larger tooth spacing resulting in a tooth pitch of approximately 0.258. These are representative tooth pitches and relative tooth pitches, as it is contemplated that cutting components changed within certain tolerances (e.g. ±10%) would exhibit substantially the same cutting characteristics.

Each of the teeth 22a-22n, with corresponding tips 24a-24n, has a substantially straight configuration with a length substantially parallel to the reciprocating travel path RP for the cutting component 16 in use.

The relevant spacing dimensions for the tips 24 shown, orthogonal to the cutting path RP, and vertically in the FIG. 7 orientation are as follows: a) smaller vertical spacing (S)=0.095 inch; and b) larger vertical spacing (L)=0.320 inch.

The angle α that each cutting edge 20a, 20b makes with the line of the cutting path RP is in the range of 50°-70′, and more preferably on the order of 60′.

The valley V1 between adjacent teeth 24g, 24h, which is representative of the valleys along the length of the cutting edge 20b between teeth having the smaller tip spacing, is defined by angled flat surfaces S1, S2.

The valley V2 between the representative teeth 22d, 22e is U-shaped or elliptical in shape.

It has been found unexpectedly that the combination of cutting teeth—coarser and finer—allows a single cutting component configuration to be utilized to maintain the ability to penetrate tough stalks while at the same time smoothly severing flexible growth, such as grasses, etc.

The invention is not limited to having two different spacings that are in a direct alternating arrangement along the length of a majority of a cutting edge. Rather, as shown in FIG. 9, the invention contemplates more generically a cutting edge 120 having teeth 122a with tips 124a having one spacing and teeth 122b having tips 124b with a different spacing, and potentially additional teeth 122c having tips 124c with a third spacing. Further, within the generic showing it is contemplated that the mixture of tooth spacing can be changed from an alternating pattern whereby virtually an unlimited number of different combinations of tooth spacing might be incorporated into a cutting edge length to exploit the benefit of both coarse and fine cutting capabilities. As a starting point, the invention contemplates that a spacing between tooth tips is non-uniform over the majority of the length of the first cutting edge.

It has been found, without limitation, that the desired cutting characteristics can be realized with the combination of a coarse tooth spacing corresponding to 3-5 teeth per inch and a finer tooth spacing corresponding to 9-14 teeth per inch.

It is also contemplated that a single cutting component 16 might be utilized, whereas multiple cutting components 16 are commonly employed, as indicated in FIG. 7, on reciprocating cutter bar constructions.

The foregoing disclosure of specific embodiments is intended to be illustrative of the broad concepts comprehended by the invention.

1. An apparatus for cutting agricultural product, the apparatus comprising:
a frame;
a first cutting component; and
a support for the first cutting component on the frame that is driven to cause the first cutting component to be moved in a cutting path,
the first cutting component having a body with a first serrated cutting edge to sever agricultural product engaged thereagainst and having a length and a plurality of teeth spaced from each other in a lengthwise direction,
wherein each tooth has a tip,
wherein a spacing between the tooth tips is non-uniform over a majority of the length of the first cutting edge.

2. The apparatus for cutting agricultural product according to claim 1 wherein the cutting path is a reciprocating cutting path.

3. The apparatus for cutting agricultural product according to claim 1 wherein the spacing between adjacent tooth tips comprises a least two different spacings over a majority of the length of the first cutting edge.

4. The apparatus for cutting agricultural product according to claim 3 wherein first and second of the spacings alternate over a majority of the length of the first cutting edge.

5. The apparatus for cutting agricultural product according to claim 4 wherein the first and second spacings alternate directly, one after the other, over a majority of the length of the first cutting edge.

6. The apparatus for cutting agricultural product according to claim 1 wherein there are U-shaped valleys between adjacent of the tips on the first cutting edge.

7. The apparatus for cutting agricultural product according to claim 1 wherein there are valleys between adjacent of the tips on the first cutting edge defined by angled flat surfaces.

8. The apparatus for cutting agricultural product according to according to claim 2 wherein the first cutting edge moves in a substantially straight first line in the reciprocating cutting path and the first cutting edge is at a first angle to the first line.

9. The apparatus for cutting agricultural product according to claim 8 wherein the first angle is in the range of 50°-70° and more preferably on the order of 60°.

10. The apparatus for cutting agricultural product according to claim 6 wherein there is a valley between adjacent of the tips on the first cutting edge defined by angled flat surfaces.

11. The apparatus for cutting agricultural product according to claim 10 wherein there are first and second different spacings between adjacent tips on the first cutting edge and the U-shaped valleys are located between adjacent of the tips with a greater of the first and second different spacings.

12. The apparatus for cutting agricultural product according to claim 1 wherein there are first and second different spacings between adjacent of the tips on the first cutting edge and a greater of the first and second different spacings corresponds to a pitch on the order of 0.258.

13. The apparatus for cutting agricultural product according to claim 12 wherein a lesser of the first and second different spacings corresponds to a pitch on the order of 0.109.

14. The apparatus for cutting agricultural product according to claim 1 wherein the first cutting component comprises a body with first and second oppositely facing surfaces and the cutting teeth are formed on a beveled surface extending between the oppositely facing surfaces.

15. The apparatus for cutting agricultural product according to claim 14 wherein the beveled surface is at an angle of 22°-25° with respect to one of the oppositely facing surfaces.

16. The apparatus for cutting agricultural product according to claim 1 wherein the first cutting component body has a second serrated cutting edge, the first and second cutting edges cooperatively defining a “V” shape.

17. The apparatus for u ng agricultural product according to claim 16 wherein the second cutting edge has substantially a same configuration as the first cutting edge.

18. The apparatus for cutting agricultural product according to claim 1 wherein a plurality of cutting components the same as the first cutting component are provided on the support and move as one piece with the support.

19. The apparatus for cutting agricultural product according to claim 1 wherein the first serrated cutting edge is substantially straight.

20. The apparatus for cutting agricultural product according to claim 2 in combination with a wheeled vehicle that supports the frame and is operable to advance the apparatus in an operating direction that is at an angle to the reciprocating cutting path.
